(19) United States
(12) Patent Application Publication
(10) Pub. No.: US 2020/0053278 A1
(43) Pub. Date: Feb. 13, 2020

(54) TECHNIQUES FOR IMPROVING PHOTOGRAPH QUALITY FOR COMMON PROBLEM SITUATIONS

(71) Applicant: Sony Corporation, Tokyo (JP)

(72) Inventor: Brant Candelore, Escondido, CA (US)

(21) Appl. No.: 16/058,468

(22) Filed: Aug. 8, 2018

(51) Int. Cl. H04N 5/232; G06T 7/00; G06T 5/00

(52) U.S. Cl. CPC H04N 5/23222; G06T 7/0002; H04N 5/232933; G06T 5/005; H04N 5/2353; G06T 2207/30168; H04N 5/23212; G06T 2207/30216; G06T 2207/30201; H04N 5/23219

(57) ABSTRACT

A photograph is processed real-time using image processing to determine whether it contains a common imaging problem. An alert is generated on the imaging device to inform the user that the image is OK, needs to be checked, has a common imaging problem, or has a problem that the camera is going to try to automatically fix by either taking a second photograph or fixing the first photograph through image processing.

### FIELD

The present application relates to technically inventive, non-routine solutions that are necessarily rooted in computer technology and that produce concrete technical improvements.

### BACKGROUND

Many cameras, such as the Sony Alpha™ or RX100 series of dedicated cameras or built-in to the Sony Experia® smart phones, come in small packages with small screens. Such cameras may still be able to render high resolution images, but as understood herein, it can be difficult to see smudges and dirt on the small lenses, and the images on the screen in bright light (in the sun) and because the camera images on the screen are just too small or of lower resolution even if the image itself is of high resolution. If a flaw in the image is subsequently discovered when, e.g., the camera is relocated into low light or the image downloaded to a larger or higher resolution screen device, it is usually impractical or unfeasible to recreate the scene, such as for a group photo or a summit photo during a mountain hike. It would be desirable to know right away that when an image is taken, that it passes some immediate basic photographic and compositional checks. And if not, take corrective action right away while taking a new photograph in the setting is still possible if need be.

### SUMMARY

Present principles recognize the above problems and so provide an assembly with a housing. At least one processor is in the housing, and at least one imager is supported on the housing and is configured to communicate with the processor. At least one computer storage also is in the housing and includes instructions executable by the processor to render a first photograph. The instructions are executable to, responsive to the first photograph comprising a common image problem of some type, generate a first signal to cause an alert to be presented on the assembly, and/or, if applicable, to correct the image problem, e.g. exposure, focus or composition, in order to cause a second photograph to be rendered manually or automatically, or to fix the first photograph automatically through image processing without user intervention. There can be many problems with picture taking. Example common problems are as follows:
1) A smudge or debris in the optical path, e.g. on the lens or sensor.
   a. The camera may be able to “fix” this problem using the first photograph and image processing. The “fix” may not be to the photographer's liking however, and so the photographer may need to be alerted to this problem even if it can be fixed. A setting on the camera may allow for severity. If the smudge is below a certain threshold of affected pixels, then the camera may attempt the fix alerting the photographer of that situation, and if not then alert the photographer that manual intervention is necessary, e.g. the smudge or debris must be manually removed.
2) One or more subjects has their eyes closed.
   a. The camera may be able to “fix” this problem using the first photograph and image processing. The “fix” may not be to the photographer's liking however, and so the photographer may need to be alerted to this problem even if the camera will attempt to fix it.
3) One or more subjects is not actually facing the camera.
4) One or more subjects' face is not entirely seeing by the camera.
5) One or more subjects has red eye.
   a. The camera may be able to “fix” this problem using the first photograph and image processing. The “fix” may not be to the photographer's liking however, and so the photographer may need to be alerted to this problem even if the first photograph can be fixed automatically.
6) One or more subjects is not smiling.
   a. The camera may be able to “fix” this problem using the first photograph and image processing. The “fix” may not be to the photographer's liking however, and so the photographer may need to be alerted to this problem even if it can be fixed.
7) The image is out-of-focus. There are many settings for automatic focus where the photographer must tell the camera which items, e.g. one or more subjects needed to be in focus. The camera compares the items previously selected with the resultant image to determine whether they were in focus or not. The focus could be multi-part, singular, center or live-image where the movement across the field of view is tracked.
8) One or more of the faces are out-of-focus. This is a special case of just faces being tracked
9) The image is blurry. The image could be multi-part, singular or in the center.
10) Some or all parts of the image are over exposed.
11) Some or all parts of the image are under exposed.
12) Image capture is set to a lower resolution than advised (e.g. the subject is very detailed).
13) Image capture is set to a higher resolution than advised (e.g. the subject is not detailed).
14) The image just captured is almost identical to one just taken (and night be deleted to save memory space and the need to review it later). The user can enable auto-deletion (or can review the images to delete).

The user can selectively enable none, some or all of the checks above, and whether a second picture should be attempted or whether the image can be fixed using image analysis and processing. As the automatic “fixing” of the image may not be entirely to the user's liking, the user may be alerted. And the user may try to manually fix the underlying problem, e.g. physically remove the smudge of dirt on the lens or sensor and retake an image. “Red eye” prevention light flickering can be enabled, etc., instructions given to subjects to be more attentive and to be more visible, and “look” towards the camera and with their eyes open.

In some examples, the first photograph is rendered responsive to actuation of a shutter associated with the imager. The alert may include an audible alert using tones or possibly the name of the common problem said out-loud, e.g. “dirt on lens”. “eyes closed”, “not facing camera”, “not smiling”, and/or a visible alert, e.g. text in the display or a bright red LED. The audible alert can be loud enough in some cases for the people posing in for the photograph to hear it and take corrective action without further coaxing from the photographer. For example, to smile or face the camera, and to make their faces more clearly seen. The alert can be a first alert and the instructions can be executable to, responsive to the first photograph not comprising an image with a common problem, generate a second signal to cause a second alert to be presented on the assembly, with the second alert being different from the first alert. And it is possible that the camera may not able to conclusively determine if there is a problem or not, in which case, the camera could list the problem as “check—dirt on lens”, “check—eyes closed”, “check—not facing camera”, “check—not smiling”, etc. The visual indicator would be a yellow LEI). In this case, the alert can be a third alert with an image with a possible common problem. The third alert being different than the first or second alert.

As disclosed further below, the instructions can be executable to determine whether the first photograph includes an image common problem using image processing. Determining whether the first photograph includes an image of a common problem using image processing can be executed by a server receiving the first photograph. It should be noted that some cameras can be operated remotely using Wi-Fi on a smart device (not shown). This feature can also allow the smart device to receive the first photograph. And so, it is possible for the server to receive the first photograph through this intermediary smart device, for example, because it has a cellular network connection to the Internet. Or, determining whether the first photograph includes an image of a common problem using image processing can be executed by the processor of the assembly on its own.

In another aspect, a computer storage device that is not a transitory signal includes instructions executable by at least one processor to present on at least one computer display at least one user interface (UI). The UI includes at least a first selector selectable to cause an imaging device to present a first alert responsive to a first photograph taken by the imaging device being determined to include an image of at least one common problem. The UI also includes at least a second selector selectable to cause the imaging device to change the settings if need be and then automatically take a second photograph responsive to the first photograph being determined to include an image of at least one common problem, or to automatically fix the problem if possible and enabled.

In another aspect, a method includes receiving a first photograph from an imaging device imager and determining whether the first photograph comprises an image with at least one common problem. Responsive to the first photograph comprising an image with at least one common problem, the method includes generating a first signal to cause an alert to be presented on the assembly, and/or causing a second photograph to be rendered automatically or image fixed without user intervention.

The details of the present disclosure, both as to its structure and operation can be best understood in reference to the accompanying drawings, in which like reference numerals refer to like parts, and in which:

### BRIEF DESCRIPTION OF THE DRAWINGS

FIG. 1 is a block diagram of an example system including an example in consistent with present principles;

FIG. 2 is a view of a camera implemented as a standalone device;

FIG. 3 is a view of a camera implemented as a mobile telephone,

FIG. 4 is a flow chart of example logic of a first embodiment consistent with present principles;

FIG. 5 is a flow chart of example logic of a first embodiment consistent with present principles;

FIG. 6 is a screen shot of an example user interface (UI) consistent with present principles;

FIG. 7 is a flow chart of alternate logic consistent with present principles;

FIG. 8 illustrates additional optional decision blocks that can be used in FIG. 7; and

FIG. 9 is a table of example non-limiting post-processing for various common image problems.

### DETAILED DESCRIPTION

This disclosure relates generally to computer ecosystems including aspects of consumer electronics (CE) device-based user information in computer ecosystems. A system herein may include server and client components, connected over a network such that data may be exchanged between the client and server components. The client components may include one or more computing devices including imaging devices such as standalone digital cameras and cameras in mobile telephones, alone or in conjunction with portable televisions (e.g. smart TVs, Internet-enabled TVs), portable computers such as laptops and tablet computers, and other mobile devices. These client devices may operate with a variety of operating environments. For example, some of the client computers may employ, as examples, operating systems from Microsoft, or a Unix operating system, or operating systems produced by Apple, Inc. or Google. These operating environments may be used to execute one or more browsing programs, such as a browser made by Microsoft, Apple, Inc. or Google or Mozilla or other browser program that can access web applications hosted by the Internet servers discussed below.

Servers may include one or more processors executing instructions that configure the servers to receive and transmit data over a network such as the Internet. Phones, tablets connected over a cellular 5G network have the bandwidth to rapidly transmit photographs to a server for post processing. As mentioned previously, the camera may be connected via Wi-Fi to one of these smart devices where the smart device acts as a type of remote control. This feature often allows the smart device to also receive the photograph. And so, the server can receive the photograph via this intermediary smart device. A client and server can be also connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions can be implemented in software, firmware or hardware and include any type of programmed step undertaken by components of the system. Instructions may be downloadable to a camera or other networked device from a server as an “application”.

A processor may be any conventional general-purpose single- or multi-chip processor that can execute logic by means of various lines such as address lines, data lines, and control lines and registers and shift registers.

Software modules described by way of the flow charts and user interfaces herein can include various sub-routines, procedures, etc. Without limiting the disclosure, logic stated to be executed by a particular module can be redistributed to other software modules and/or combined together in a single module and/or made available in a shareable library.

Present principles described herein can be implemented as hardware, software, firmware, or combinations thereof hence, illustrative components, blocks, modules, circuits, and steps are set forth in terms of their functionality.

Further to what has been alluded to above, logical blocks, modules, and circuits described below can be implemented or performed with a general-purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

The functions and methods described below, when implemented in software, can be written in an appropriate language such as but not limited to C# or C++, and can be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections can include, as examples, hard-wired cables including fiber optic and coaxial wires and digital subscriber line (DSL) and twisted pair wires.

Components included in one embodiment can be used in other embodiments in any appropriate combination. For example, any of the various components described herein and/or depicted in the Figures may be combined, interchanged or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

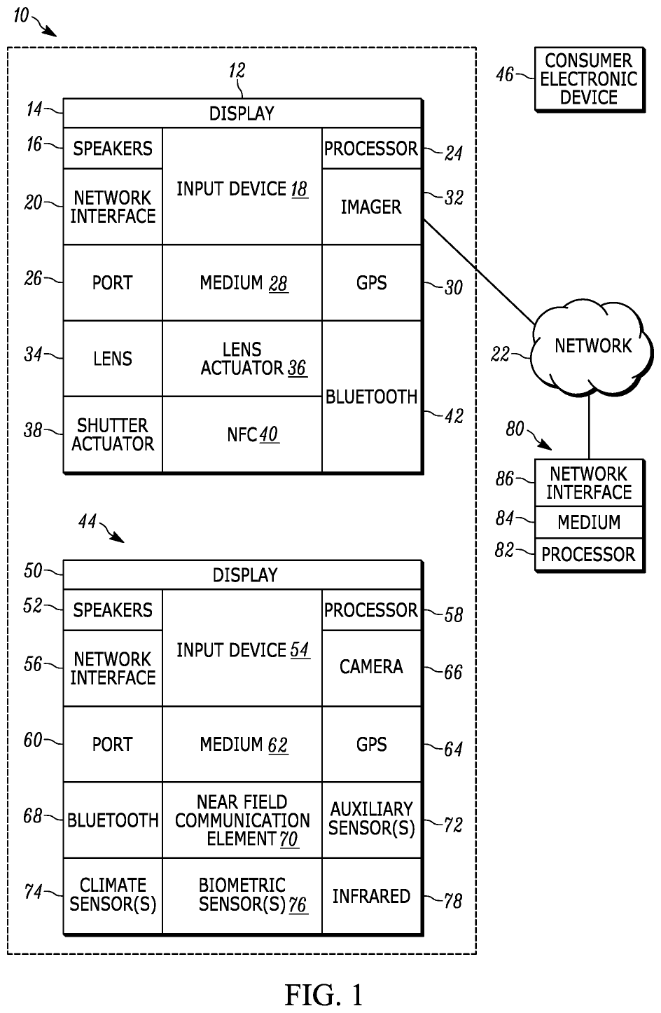

Now specifically referring to FIG. 1, an example ecosystem 10 is shown, which may include one or more of the example devices mentioned above and described further below in accordance with present principles. The first of the example devices included in the system 10 is an example imaging device (ID) 12 that may be a standalone imaging device or an imaging device incorporated in another apparatus such as a mobile telephone, mobile computer, etc. Regardless, it is to be understood that the ID 12 is configured to undertake present principles (e.g. communicate with other CE devices to undertake present principles, execute the logic described herein, and perform any other functions and/or operations described herein).

Accordingly, to undertake such principles the ID 12 can be established by some or all of the components shown in FIG. 1. For example, the ID 12 can include one or more displays 14 that may be touch-enabled for receiving consumer input signals via touches on the display. The ID 12 may include one or more speakers 16 for outputting audio in accordance with present principles, and at least one additional input device 18 such as e.g. an audio receiver/microphone for e.g. entering audible commands to the ID 12 to control the ID 12, control keys for entering commands and/or data, etc. The example ID 12 may also include one or more network interfaces 20 for communication over at least one network 22 such as the Internet, a. WAN, a LAN, etc. under control of one or more processors 24. Thus, the interface 20 may be, without limitation, a Wi-Fi transceiver, which is an example of a wireless computer network interface. The one or more interfaces 20 may include a wireless telephony transceiver such as but not limited to a global system for communication (GSM) transceiver, a code division multiple access (CDMA) transceiver including w-CDMA, an orthogonal frequency division multiplex (OFDM) transceiver that may be part of a cellular 5G network, etc.

It is to be understood that the processor 24 controls the ID 12 to undertake present principles, including the other elements of the ID 12 described herein such as e.g. controlling the display 14 to present images thereon and receiving input therefrom. Furthermore, note the network interface 20 may be, e.g., a wired or wireless modem or router, or other appropriate interface such as, e.g., a wireless telephony transceiver, or Wi-Fi transceiver as mentioned above, etc.

In addition to the foregoing, the ID 12 may also include one or more input ports 26 such as, e.g., a USB port to physically connect (e.g. using a wired connection) to another CE device and/or a headphone port to connect headphones to the ID 12 for presentation of audio from the ID 12 to a consumer through the headphones. The ID 12 may further include one or more computer memories 28 that are not transitory signals, such as disk-based or solid-state storage (including but not limited to flash memory). Also, in some embodiments, the ID 12 can include a position or location receiver such as but not limited to a cellphone receiver, GPS receiver and/or altimeter 30 that is configured to e.g. receive geographic position information from at least one satellite or cellphone tower and provide the information to the processor 24 and/or determine an altitude at which the ID 12 is disposed in conjunction with the processor 24. However, it is to be understood that that another suitable position receiver other than a cellphone receiver, GPS receiver and/or altimeter may be used in accordance with present principles to e.g. determine the location of the ID 12 in e.g. all three dimensions.

Continuing the description of the ID 12, in some embodiments the II) 12 may include one or more imagers 32 that may be, e.g., a thermal imaging camera, a digital camera such as a webcam, and/or a camera integrated into the ID 12 and controllable by the processor 24 to gather pictures/images and/or video in accordance with present principles. An imager may be implemented by, without limitation, a charge-coupled device (CCD), complementary metal-oxide-semiconductor (CMOS) device, or backside illumination complementary metal oxide-semiconductor (BSI-CMOS).

Light from objects may enter the imager 32 through one or more lenses 34. The lens 34 may be movable by a lens actuator 36 to focus the image on the imager 32. Without limitation, the imager 32 with lens 34 may be implemented in a digital single lens reflex (DSLR) package.

One or more shutter actuators 38 may be provided on the ID 12. The shutter actuator 38 can be manipulated to cause a shutter to open or otherwise “take” a picture. The shutter actuator may be implemented by a hardware key or soft key.

Also included on the ID 12 may be a Bluetooth transceiver 42 and other Near Field Communication (NFC) element 40 for communication with other devices using Bluetooth and/or NFC technology, respectively. An example NFC element can be a radio frequency identification (RFID) element. A battery (not shown) may be provided for powering the ID 12.

Still referring to FIG. 1, in addition to the ID 12, the system 10 may include one or more other CE device types. In one example, a first CE device 44 may be used to exchange photographic and video information with the ID 12 and/or with the below-described server while a second CE device 46 may include similar components as the first CE device 44 and hence will not be discussed in detail. In the example shown, only two CE devices 44, 46 are shown, it being understood that fewer or greater devices may be used.

In the example shown, to illustrate present principles all three devices 12, 44, 46 are assumed to be members of an entertainment network.

The example non-limiting first CE device 44 may be stablished by any one of the above-mentioned devices, for example, an internet-enabled TV, a portable wireless laptop computer or tablet computer or notebook computer, and accordingly may have one or more of the components described below. The first CE device 44 alternatively may be embodied in the form of eyeglasses or a wireless telephone. The second CE device 46 without limitation may be established by a wireless telephone. The second CE device 46 may implement a portable hand-held remote control (RC).

The first CE device 44 may include one or more displays 50 that may be touch-enabled enabled for receiving consumer input signals via touches on the display. The first CE device 44 may include one or more speakers 52 for outputting audio in accordance with present principles, and at least one additional input device 54 such as e.g. an audio receiver/microphone for e.g. entering audible commands to the first CE device 44 to control the device 44. The example first CE device 44 may also include one or more network interfaces 56 for communication over the network 22 under control of one or more CE device processors 58. Thus, the interface 56 may be, without limitation, a Wi-Fi transceiver, which is an example of a wireless computer network interface. It is to be understood that the processor 58 may control the first CE device 44 to undertake present principles, including the other elements of the first CE device 44 described herein such as e.g. controlling the display 50 to present images thereon and receiving input therefrom. Furthermore, note the network interface 56 may be, e.g., a wired or wireless modem or router, or other appropriate interface such as, e.g., a wireless telephony transceiver, or \Vi-Fi transceiver as mentioned above, etc.

In addition to the foregoing, the first CE device 44 may also include one or more input ports 60 such as, e.g., a USB port to physically connect (e.g. using a wired connection) to another CE device such as the ID 12 and/or a headphone port to connect headphones to the first CE device 44 for presentation of audio from the first CE device 44 to a consumer through the headphones. The first CE device 44 may further include one or more computer memories 62 such as disk-based or solid-state storage. Also in some embodiments, the first CE device 44 can include a position or location receiver such as but not limited to a cellphone and/or GPS receiver and/or altimeter 64 that is configured to e.g. receive geographic position information from at least one satellite and/or cell tower using triangulation, and provide the information to the CE device processor 58 and/or determine an altitude at which the first CE device 44 is disposed in conjunction be CE device processor 58. However, it is to be understood that that another suitable position receiver other than a cellphone and/or GPS receiver and/or altimeter may be used in accordance with present principles to e.g. determine the location of the first CE device 44 in e.g. all three dimensions.

Continuing the description of the first CE device 44, in some embodiments the first CE device 44 may include one or more cameras 66 that may be, e.g., a thermal imaging camera, a digital camera such as a webcam, and/or a camera integrated into the first CE device 44 and controllable by the CE device processor 58 to gather pictures/images and/or video in accordance with present principles. Also included on the first CE device 44 may be a Bluetooth transceiver 68 and other Near Field Communication (NFC) element 70 for communication with other devices using Bluetooth and/or NFC technology, respectively. An example NFC element can be a radio frequency identification (RFID) element.

Further still, the first CE device 44 may include one or more auxiliary sensors 72 (e.g., a motion sensor such as an accelerometer, gyroscope, cyclometer, or a magnetic sensor, an infrared (IR) sensor, an optical sensor, a speed and/or cadence sensor, a gesture sensor for sensing gesture command, etc.) providing input to the CE device processor 58. The first CE device 44 may include still other sensors such as e.g. one or more climate sensors 74 (e.g. barometers, humidity sensors, wind sensors, light sensors, temperature sensors, etc.) and/or one or more biometric sensors 76 providing input to the CE device processor 58. In addition to the foregoing, it is noted that in some embodiments the first CE device 44 may also include an infrared (IR) transmitter and/or IR receiver and/or IR transceiver 78 such as an IR data association (IRDA) device. A battery (not shown) may be provided for powering the first CE device 44.

The second CE device 46 may include some or all of the components shown for the CE device 44.

Now in reference to the afore-mentioned at least one server 80, it includes at least one server processor 82, at least one computer memory 84 such as disk-based or solid-state storage, and at least one network interface 86 that, under control of the server processor 82, allows for communication with the other devices of FIG. 1 over the network 22, and indeed may facilitate communication between servers and client devices in accordance with present principles. Note that the network interface 86 may be, e.g., a wired or wireless modem or router, Wi-Fi transceiver, or other appropriate interface such as, e.g., a wireless telephony transceiver.

Accordingly, in some embodiments the server 80 may be an Internet server and may include and perform “cloud” functions such that the devices of the system 10 may access a “cloud” environment via the server 80 in example embodiments. Or, the server 80 may be implemented by a game console or other computer in the same room as the other devices shown in FIG. 1 or nearby.

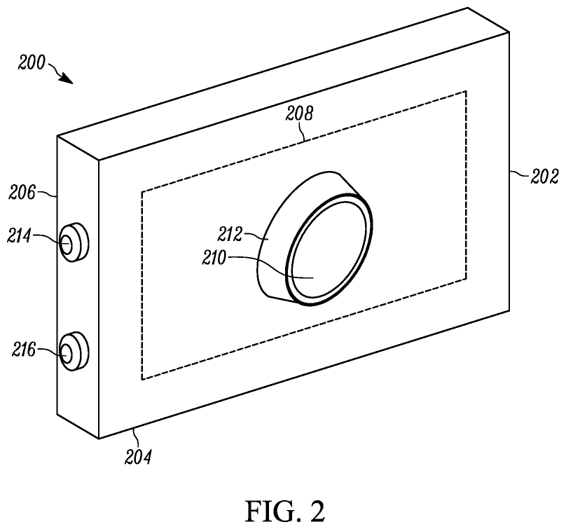

FIG. 2 illustrates a first example implementation of the ID 12, showing a standalone camera device 200 with a housing 202 containing components described above and having a front 204 and a back 206 (relative to the user, with the back 206 facing the user when in use to take pictures). A display 208 (shown in phantom in FIG. 2) may be part of the back 206 of the camera device 200. The display 208 can present images as generated by the imager within the housing 202.

As shown in FIG. 2, the camera device 200 may include a lens 210 that may be moved be a lens actuator 212 to focus the image on the imager behind the lens (not shown). In the example of FIG. 2, a shutter actuator button 214 is on the housing 202 and can be manipulated to capture an image to “take a picture” as a digital photograph. If desired, one or more lamps 216 such as light emitting diodes (LEDs) or other lamps may be provided.

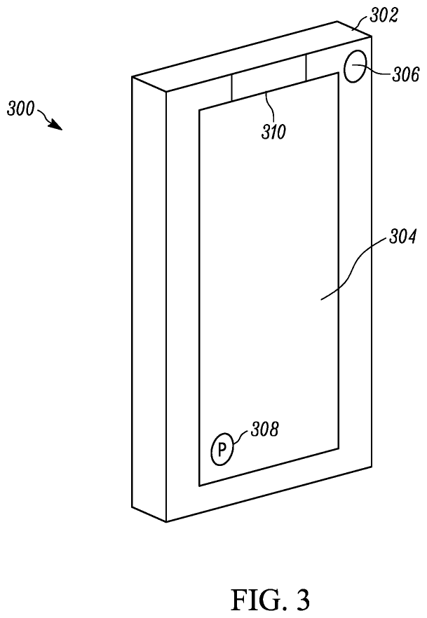

FIG. 3 illustrates a second example implementation of the ID 12, implemented as a mobile telephone 300 with a housing 302 containing components described above. A display 304 is on the housing 302 to present images as generated by the imager within the housing 302. A lens 306 is provided to focus the image on the imager behind the lens (not shown). The display 304 may be touch-enabled and may present a soft shutter actuator 308 that can be manipulated to capture an image to “take a picture” as a digital photograph. If desired, one or more lamps 310 such as light emitting diodes (LEDs) or other lamps may be provided, in the example shown, behind a bezel or display but visible therethrough. The LEDs described herein may be multi-colored to illuminate in one of multiple available colors such as green, red, and blue under command of the processor of the device.

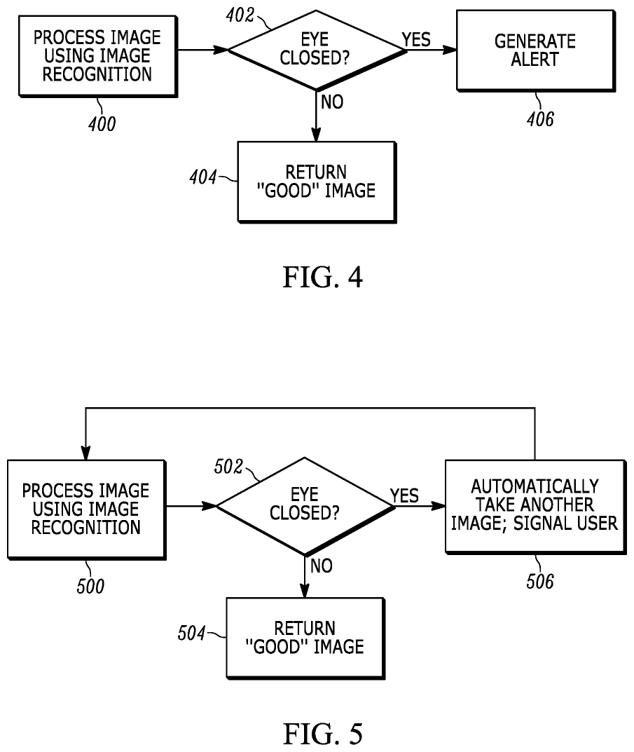

FIGS. 4 and 5 show logic that may be executed by any of the imaging devices described herein locally and/or in connection with offloading information to the server 80 for analysis and return of output information relating to whether a photograph is “good”, “needs to be checked”, or not. The server 80 may be reached via an intermediary smart device (not shown) that is in communication with both the server and the processor 24. FIG. 4 commences at block 400 after an image is captured typically by manipulating a shutter actuator. With modem day imaging devices, mechanical shutter may no longer be employed. The shutter actuator may simply signal to the imager to freeze the current image being processed. Present principles understand that while pre-processing of certain image features such as for focus, face detect, or eye detect, smile detect or other analysis of “unacceptable” image features may be performed, between the time the pre-processing may output a signal indicating that subjects in the image field are ready to be photographed (“acceptable”) and the time the photographer actuates the shutter, the situation may have changed from “acceptable” to “unacceptable”—the subject may have moved, the focus changed, etc.

Accordingly, once an image is captured to render a photograph by, e.g., actuating the shutter actuator, the process in FIG. 4 begins at block 400 to process the image using image processing. In the case of one or more subjects with their eyes closed, the eyes of subjects in the photograph may be identified using image processing. Not that FIG. 4 may be executed wholly by the imaging device itself, or the imaging device may upload the photograph to the server 80 with the server 80 executing blocks 402-406.

Moving to decision diamond 402 it is determined from image processing whether one or more eyes are closed in the captured image. This may be determined by, e.g., determining whether the color of one or more eyes in the image is flesh-toned or matches another test color indicating that the eye is covered by an eyelid. Or, the images of the eyes in the captured photograph may be compared against a database of eye images, some open and some closed, with the closest match being returned as an indication of whether the eye is open or closed in the photograph.

If the image is acceptable (in this case, no eyes closed in the photograph), the logic moves to block 404 to return “good image”. On the other hand, if there is a flaw in the image, the logic moves to block 406 to generate an alert to indicate that the photograph has a flaw in it.

In example embodiments, responsive to a “good image” being returned at block 404, the imaging device may take no further action. Or, the imaging device may illuminate a lamp such as a green LED indicating the photograph is “good” or acceptable. In addition, or alternatively, the imaging device may actuate its speaker(s) to play one or more sounds, such as a pleasant chime, indicating that the photograph is “good” or acceptable.

On the other hand, responsive to the output of a “bad” or unacceptable photograph signal at block 406, the imaging device may illuminate a lamp such as a red LEI) indicating the photograph is “no good” or unacceptable. In addition, or alternatively, the imaging device may actuate its speaker(s) to play one or more sounds, such as an unpleasant buzz, indicating that the photograph is “no good” or unacceptable.

FIG. 5 commences at block 500 after an image is captured typically by manipulating a shutter actuator. Once an image is captured by, e.g., actuating the shutter actuator, the process in FIG. 5 begins at block 500 to process the image using image processing. In the instant case, the eyes of subjects in the photograph may be identified using image recognition. Note that FIG. 5 may be executed wholly by the imaging device itself, or the imaging device may upload the photograph to the server 80 with the server 80 executing blocks 502-506.

Moving to decision diamond 502 it is determined from image processing whether one or more eyes are closed in the captured image. This may be determined by, e.g., determining whether the color of one or more eyes in the image is flesh-toned or matches another test color indicating that the eye is covered by an eyelid. Or, the images of the eyes in the captured photograph may be compared against a database of eye images, some open and some closed, with the closest match being returned as an indication of whether the eye is open or closed in the photograph.

If the image is acceptable (in this case, no eyes closed in the photograph), the logic moves to block 504 to return “good image”. On the other hand, if there is a flaw in the image, the logic moves to block 506 to generate an alert to indicate that the photograph has a flaw in it, and to automatically, without user intervention such as manipulation of a shutter actuator, capture another image as another photograph and loop back to block 500 to process the second photograph using image processing as described for the initial photograph. The user will hear a different alert when the camera attempts to fix the underlying issue—retake the photograph or fix the photograph using image processing.

In example embodiments, responsive to a “good image” being returned at block 504, the imaging device may take no further action. Or, the imaging device may illuminate a lamp such as a green LED indicating the photograph is “good” or acceptable. In addition, or alternatively, the imaging device may actuate its speaker(s) to play words, or one or more sounds, such as a pleasant chime, indicating that the photograph is “good” or acceptable.

On the other hand, responsive to the output of a “bad” or unacceptable photograph signal at block 506, the imaging device may illuminate a lamp such as a red LED indicating the photograph is “no good” or unacceptable. In addition, or alternatively, the imaging device may actuate its speaker(s) to play words, or one or more sounds, such as an unpleasant buzz, indicating that the photograph is “no good” or unacceptable. In lieu of or in addition to presenting an audible and/or visual alert at block 406, anther photograph is automatically taken without user intervention. If the camera attempts a fix, the alert can be different than when the camera does not attempt a fix.

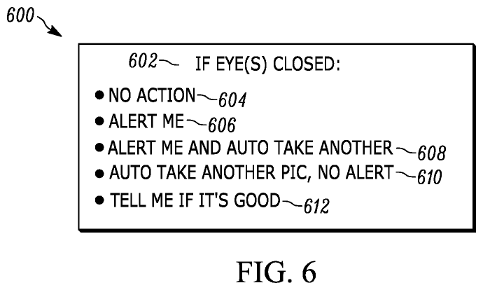

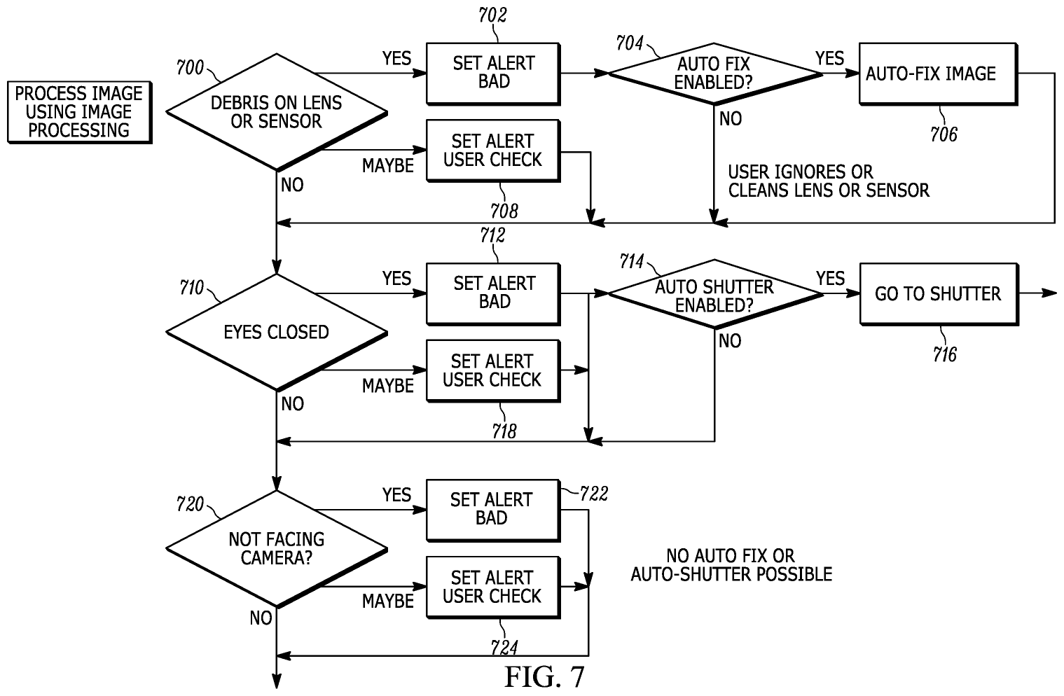

FIG. 6 illustrates an example screen shot of a user interface (UI) 600 that can be presented on any of the displays herein, such as any of the displays of imaging devices shown in FIGS. 1-3. A prompt 602 may be presented indicating to the user that be can select responses to be executed if one or more eyes are determined to be closed in FIG. 4 or 5.

A first selector 604 may be selected to indicate that no action is to be taken at block 406 or block 506, i.e., that no alert is to be presented. A second selector 606 may be presented to generate only an alert at block 406 or block 506.

Selectors 608 and 610 may be presented appendant to the logic of FIG. 5 to indicate, respectively, that another photograph is to be taken at block 506 without alerting the user that a flaw exists in the initial photograph and that another photograph is to be taken at block 506 while also alerting the user that a flaw exists in the initial photograph.

If desired, a selector 612 may be selectable to indicate whether a “good photograph” alert is to be output as disclosed above at block 404 or 504 when the photograph is good or acceptable.

Turning now to FIG. 7, further principles consistent with previous disclosure may be seen. Commencing at decision diamond 700, an image after capturing is post-processed to determine whether debris may be on the lens or imaging sensor itself. As is the case with detecting other common problems noted herein, this determination may be accomplished by comparing groups of pixels in the image, including color, contrast, shape of the groups, etc. against a database or other information of expected “normal” image components.

If the test at decision diamond 700 is positive, the logic may glow to block 702 to return “had” alert, indicating a problem with the image (in this case, the problem tested for at decision diamond 700). This action may cause a light emitting diode (LED) on the imaging device, such as a red LED to illuminate. The name of problem tested for may also be presented in alpha-numeric form on the display of the imaging device. Moreover, the name of the problem tested for may be played in verbal form on one or more speakers such as may be included on the imaging device or a nearby headphone in communication e.g., Bluetooth) with the imaging device and receiving announcement information therefrom Or, a particular tone or other non-verbal sound may be emitted that is designated as a tone or sound indicating a “bad image” alert. Only one of the above modes of alert may be used or any combination thereof may be used.

Moving from block 702 to decision diamond 704, it can be determined whether the user has enabled automatically fixing the problem, e.g., using the example UI in FIG. 6. If so, the image can be automatically fixed at block 706 using post-processing for example, by replacing pixels identified as being images of random debris with pixels that can be averaged using the “N” pixels adjacent the pixels affected by the problem, wherein “N” is an integer. The logic loops back to identify possible other problems from block 706 or decision diamond 704 if the test there was negative.

As indicated looking at decision diamond 700, the test for whether a problem exists may be multi-leveled, such that when a problem in the image definitively satisfies a test the process may move to block 702, but when a problem in the image only partially satisfies the test or otherwise does not return a definitive match, the logic may instead move from decision diamond 700 to block 708. At block 708 an alert (“user should check”) is generated that is different from the alert at block 702 for the definitive problem test. The alert at block 708 may include illuminating an LED on the imaging device such as a yellow LED (or other color different than the one used at block 702) or it may include illuminating the same LED but in a different pattern (e.g., blinking in one case, continuously illuminated in the other). The name of problem tested for may also be presented in alpha-numeric form on the display of the imaging device along with a prompt to check the image. Moreover, the name of the problem tested for along with an audible prompt to check the image may be played in verbal form on one or more speakers such as may be included on the imaging device or a nearby headphone in communication Bluetooth) with the imaging device and receiving announcement information therefrom. Or, a particular tone or other non-verbal sound may be emitted that is designated as a tone or sound indicating a “check image” alert. Only one of the above modes of alert may be used or any combination thereof may be used.

Note that if no problem is detected in the image, yet a third LED color, e.g., green, may be illuminated or a “good” pattern of illumination precipitated, and/or a “good photo” voice alert or tone played on speakers.

FIG. 7 indicates that additional common problems may be tested for. For example, at decision diamond 710 it may be determined whether one or more eyes in the image are closed as described above. If the test at decision diamond 710 is positive, the logic may glow to block 712 to return “bad” alert, indicating a problem with the image (in this case, the problem tested for at decision diamond 710). This action may cause a light emitting diode (LED) on the imaging device, such as a red LED to illuminate. The name of problem tested for may also be presented in alpha-numeric form on the display of the imaging device. Moreover, the name of the problem tested for may be played in verbal form on one or more speakers such as may be included on the imaging device or a nearby headphone in communication (e.g., Bluetooth) with the imaging device and receiving announcement information therefrom. Or, a particular tone or other non-verbal sound may be emitted that is designated as a tone or sound indicating a “bad image” alert. Only one of the above modes of alert may be used or any combination thereof may be used.

Moving from block 712 to decision diamond 714, it can be determined whether the user has enabled automatically taking another image, e.g., using the example UI in FIG. 6. If so, another image can be automatically captured at block 716. The logic loops back to identify possible other problems from block 716 or decision diamond 714 if the test there was negative.

As indicated looking at decision diamond 710, the test for whether a problem exists may be multi-leveled, such that when a problem in the image definitively satisfies a test the process may move to block 712, but when a problem in the image only partially satisfies the test or otherwise does not return a definitive match, the logic may instead move from decision diamond 710 to block 718. At block 718 an alert (“user should check”) is generated that is different from the alert at block 712 for the definitive problem test. The alert at block 718 may include illuminating an LED on the imaging device such as a yellow LED (or other color different than the one used at block 712) or it may include illuminating the same LED but in a different pattern (e.g., blinking in one case, continuously illuminated in the other). The name of problem tested for may also be presented in alpha-numeric form on the display of the imaging device along with a prompt to check the image. Moreover, the name of the problem tested for along with an audible prompt to check the image may be played in verbal form on one or more speakers such as may be included on the imaging device or a nearby headphone in communication (e.g., Bluetooth) with the imaging device and receiving announcement information therefrom. Or, a particular tone or other non-verbal sound may be emitted that is designated as a tone or sound indicating a “check image” alert. Only one of the above modes of alert may be used or any combination thereof may be used.

Decision diamond 720 represents a common problem of a different nature than those tested for at decision diamonds 700 and 710, namely, whether image recognition indicates that one or more heads are in the image but not facing the camera, as indicated by detecting a shape if the correct size and shape as a head but no (or insufficient) facial features, such as no nose, only one eye, half of a mouth, etc. An image that definitively meets the test may result in the setting of a “bad” alert at block 722 whereas an image that does not definitively result in “good” image but also does not definitively result in “bad” image may return a “user should check” alert at block 724. No further action is taken in this case because an automatic fix by post-processing typically is not possible to reconstruct the details of the missing facial features, and immediately taking another image may still capture the person looking the wrong way.

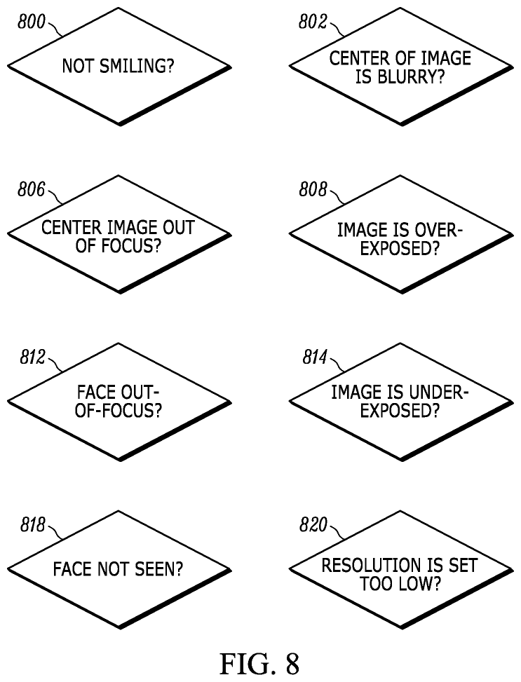

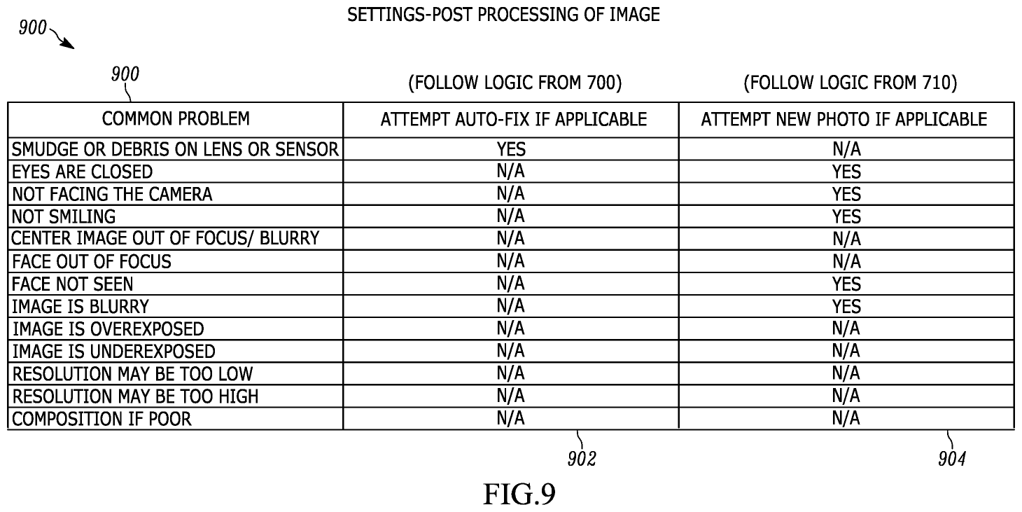

FIGS. 8 and 9 generalize the above principles by indicating additional problems that can be tested for in images and solutions thereto, to indicate which of the lines of logic flow in FIG. 7 are to be followed (the flow from decision diamond 700 or 710 or 720) for each additional problem. In FIG. 9, the problems 900 indicated by select diamonds in FIG. 8 are associated with a first column 902 indicating whether to automatically correct the problem using post-image processing of the image along the lines of the logic proceeding to the right from decision diamond 700 in FIG. 7, and a second column 904 indicating whether to automatically taking a new image along the lines of the logic proceeding to the right from decision diamond 710 in FIG. 7. If “not applicable” (“N/A”) appears in both columns 902, 904 for a particular problem 900, the problem is dealt with along the lines of the logic proceeding to the right from decision diamond 720 in FIG. 7.

As indicated in FIG. 8, the lack of a subject smile may be tested for at decision diamond 800. Step 802 tests for whether the center of the image is blurry. Step 806 tests for whether the center of the image is out of focus. Step 808 tests for whether the image is over-exposed. Step 812 tests for whether an object in the image identified as a human face is out of focus. Step 814 tests for whether the image is under-exposed. Step 818 tests for whether an object in the image identified as a human head does not show a complete face. Test 820 tests for whether the resolution is too low or too high.

While particular techniques are herein shown and described in detail, it is to be understood that the subject matter which is encompassed by the present application is limited only by the claims.

1. An assembly, comprising:
at least one processor;
at least one imager configured to communicate with the processor;
at least one computer storage comprising instructions executable by the processor to:
render a first photograph;
using real-time post-processing, detecting that the first photograph contains an imaging problem;
responsive to the first photograph containing an imaging problem perform at least one of the following:
re-focus, adjust shutter speed and aperture settings, or adjust resolution settings and re-render a second photograph without user intervention,
leave existing focus and settings alone, and re-render a second photograph without user intervention; and
responsive to the first photograph not containing an imaging problem, generate an audible alert that signals that the first photograph passes at least one photographic check.

2. The assembly of claim 1, wherein the instructions are executable to:
responsive to the first photograph containing an imaging problem perform one of the following:
image process the first photograph to remove the imaging problem.

3. The assembly of claim 1, wherein the instructions are executable to: responsive to the first photograph, generate an audible alert that signals
the first photograph has an imaging problem that the camera will attempt to fix by either taking a second photograph or image process the first photograph.

4. The assembly of claim 1, wherein the instructions are executable to, responsive to the first photograph containing an imaging problem, re-focus, adjust shutter speed and aperture settings, or adjust resolution settings and re-render a second photograph without user intervention.

5. The assembly of claim 1, wherein the instructions are executable to, responsive to the first photograph containing an imaging problem, leave existing focus and settings alone, and re-render a second photograph without user intervention.

6. The assembly of claim 1, wherein the instructions are executable to, responsive to the first photograph, generate a first alert and the instructions are executable to:
responsive to the first photograph not comprising an imaging problem, generate a second signal to cause a second alert to be presented on the assembly, the second alert being different from the first alert.

7. The assembly of claim 1, wherein the instructions are executable to, responsive to the first photograph, generate a first alert or second alert and the instructions are executable to:
responsive to the first photograph potentially comprising an image with an imaging problem, generate a third signal to cause a third alert to be presented on the assembly, the third alert being different from the first and second alert.

8. The assembly of claim 1, wherein the instructions are executable to: responsive to the first photograph, generate a first, second, and third alerts responsive to the first photograph being automatically fixed by a camera signal to generate a fourth alert on the assembly, the fourth alert being different from the first, second and third alert.

9. The assembly of claim 3, wherein the audible alert is a voice that describes the status with the image being a “good picture”, “check picture” with potential problem, “bad picture” with problem, and “bad picture” with problem and “camera will fix”.

10. The assembly of claim 1, wherein the instructions are executable to:
determine whether the first photograph comprises one of the following:
a smudge or debris on the lens or sensor either below a threshold of affected pixels or an imager setting, the instructions being executable to correct the first photograph using image processing;
one or more subjects in the first photograph is not facing the camera, the instructions being executable to, in response, automatically generate another photograph;
one or more subjects in the first photograph is not facing the camera, the instructions being executable to, in response, output an audible alert and automatically generate another photograph;
one or more subjects' face is not entirely imaged by the camera, the instructions being executable to, in response, automatically generate another photograph;
one or more subjects' face is not entirely imaged by the camera, the instructions being executable to, in response, output an audible alert and automatically generate another photograph;
one or more eyes in the first photograph is red, the instructions being executable to, in response, change color of the one or more eyes;
one or more subjects in the first photograph is not smiling, the instructions being executable to, in response, automatically generate another photograph;
one or more subjects in the first photograph is not smiling, the instructions being executable to, in response, output an audible alert and automatically generate another photograph;
a targeted zone of the image in the first photograph is out-of-focus, the instructions being executable to, in response, automatically re auto-focus and generate another photograph;
one or more of faces in the first photograph are out-of-focus, the instructions being executable to, in response, automatically generate another photograph;
one or more of faces in the first photograph are out-of-focus, the instructions being executable to, in response, automatically re auto-focus and generate another photograph;
a targeted zone of the image in the first photograph is blurry, the instructions being executable to, in response, automatically change the shutter speed and aperture settings generate another photograph;
at least a part of an image in the first photograph is over exposed, the instructions being executable to, in response, automatically generate another photograph;
at least a part of an image in the first photograph is over exposed, the instructions being executable to, in response, change the shutter speed and aperture settings and automatically generate another photograph;
at least a part of an image in the first photograph is under exposed, the instructions being executable to, in response, automatically generate another photograph;
at least a part of an image in the first photograph is under exposed, the instructions being executable to, in response, change the shutter speed and aperture settings automatically generate another photograph;
image capture is set to a lower resolution than a threshold;
image capture is set to a higher resolution than a threshold;
an image just captured in the first photograph is almost identical to one just taken prior to the first photograph, the instructions being executable to automatically delete the first photograph, or the image just taken prior to the first photograph.

11. The assembly of claim 10, wherein determining whether the first photograph has a photographic problem is executed by a server receiving the first photograph and communicating back with the processor in the assembly.

12. The assembly of claim 10, wherein determining whether the first photograph has a photographic problem is executed by the processor of the assembly.

13. A computer storage device that is not a transitory signal and that comprises instructions executable by at least one processor to:
present on at least one computer display at least one user interface (UI) comprising:
at least a first selector selectable prior to taking the photograph to cause an imaging device to present a first alert responsive to a first photograph taken by the imaging device being determined to comprise an image with an imaging problem; and
at least a second selector selectable prior to taking the first photograph to cause the imaging device to automatically take a second photograph responsive to the first photograph being determined to comprise an image with an imaging problem.

14. The computer storage device of claim 13, wherein the UI comprises at least a third selector selectable before taking the first photograph to cause the imaging device to both present the first alert and take the second photograph responsive to the first photograph being determined to comprise an image with an imaging problem.

15. The computer storage device of claim 13, wherein the UI comprises at least a third selector selectable before taking the first photograph to cause the imaging device not to generate the first alert or take the second photograph responsive to the first photograph being determined to comprise an image with an imaging problem.

16. The computer storage device of claim 13, wherein the UI comprises at least a third selector selectable to cause the imaging device to generate a second alert responsive to the first photograph being determined not to comprise an image with an imaging problem.

17. A method, comprising:
receiving a first photograph from an imaging device imager;
identifying that one or more subject faces in the first photograph is not entirely imaged by the camera;
responsive to identifying that one or more subject faces in the first photograph is not entirely imaged by the camera, causing a second photograph to be rendered automatically without user intervention.

18. The method of claim 17, comprising:
responsive to identifying that one or more subject faces in the first photograph is not entirely imaged by the camera, generating a first signal to cause an alert to be presented on the assembly.

19. The method of claim 17, comprising:
responsive to identifying that one or more subject faces in the first photograph is not entirely imaged by the camera, generating a first signal to cause a second photograph to be rendered automatically without user intervention.

20. The method of claim 17, comprising:
responsive to identifying that one or more subject faces in the first photograph is not entirely imaged by the camera, generating a first signal to cause an alert to be presented on the assembly and causing a second photograph to be rendered automatically without user intervention.
